(19) United States
(12) Patent Application Publication
(10) Pub. No.: US 2006/0010059 A1
(43) Pub. Date: Jan. 12, 2006

(54) Investment information providing system of which working display may be set by a user, and a method thereof

(76) Inventor: SangHwan Park, Goyang-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/149,961

(22) Filed: Jun. 10, 2005

Related U.S. Application Data
(63) Continuation of application No. PCT/KR03/02710, filed on Dec. 11, 2003.

(30) Foreign Application Priority Data
Dec. 11, 2002 (KR) 10-2002-0078924

(51) Int. Cl. G06F 15/16; G06Q 40/00

(52) U.S. Cl. 705/35; 709/202

(57) ABSTRACT

The present invention provides a system and a method wherein a user can set working window display in an investment information providing system according to his/her own preference or needs.

### CROSS-REFERENCE TO RELATED APPLICATIONS

This application is a continuation under 35 U.S.C. § 365 (c) of International Application No. PCT/KR2003/002710, filed Dec. 11, 2003, designating the United States and claiming for the benefit of the earlier filing dates under 35 U.S.C. § 365 (b) of Korean Patent Application No. 10-2002-0078924 filed Dec. 11, 2002. International Application No. PCT/KR2003/002710 was published as WO 2004/053691. The International Application No. PCT/KR2003/002710 and the publication WO 2004/053691 are hereby incorporated herein by reference in their entiety.

### FIELD OF INVENTION

The present invention relates to a technique of providing investment information on stocks, futures, options, bonds, foreign exchange, global financial markets, etc. through wire or wireless communication networks, and particularly to a system, a method and a recording medium thereof wherein a screen to display investment information can be freely configured by a user, and pieces of information displayed in each screen can be provided in order to be organically related to each other.

### DEFINITIONS

Terms used herein will be defined as follows:

A “window” means a window which displays certain tasks or information, and can be divided into a plurality of display sections. A display section set within a window is referred to as a “sub-display section”. Further, a window can include another window.

A “main window” means a window is being activated by a current user.

An “investment category” or “category” in short means an item on investment information such as the current price of a share of stock, trading volume, financial statements, rate of change, etc.

A “sub-element” means investment information in a certain investment information category. For example, a sub-element with regard to the current price category of a certain stock means the investment information that indicates the current price of a share of the stock. The data value of a certain sub-element, generally, changes depending on time, and a certain data value is given at a certain time so that specific information can be presented to a user.

### DESCRIPTION OF RELATED TECHNOLOGY

Recently, Internet users have been increasing dramatically due to the progress of information technology and computer, and techniques for providing information through communication networks become more diverse. Such progress of technology has affected investment information providing systems on stocks, futures, options, bonds, foreign currencies, etc., and now a technique by which many people can be provided with the investment information on current stock price, current situation of price change, etc. through communication networks without visiting any trading floor and place an order has been presented.

According to such conventional investment information providing system, the display format of every window to provide investment information is already fixed before provided. In other words, the entire display section of a window by which certain investment information is provided is fixed as one or more sub-display section(s) divided in order to display certain investment information categories according to the setting when designing the system.

For example, a window is divided into several sub-display sections, and each of the sub-display sections is designed to display the current price of a share of certain stock, daily/weekly/monthly price change, actual price, chart, etc. In this case, the sub-elements of categories not designed to be displayed in advance such as company information on a current issue, information on other issues, etc. cannot be displayed within the window. Further, according to such conventional investment information providing system, only the information from one of the markets of stocks, options, bonds, etc. is displayed on only one window, and the information from other markets may not be displayed on the same window.

Therefore, there is a problem that a user has to open a new window in order to see the sub-elements of a category other than the categories set in advance to display sub-elements in the sub-display sections included a main window. It is inconvenient that the user may have to work with several windows, and also the task with two or more windows occupies too many system resources of a computer on operating. Further, the processing speed of the computer can be decreased, some other tasks may not be performed promptly, or the system may be even stopped abnormally.

Moreover, according to such conventional investment information providing system, also there is a problem that irrelevant information is displayed because pieces of information displayed in a plurality of windows are not organically related to each other. That is, if two windows are displaying the current price and trading volume respectively, even though a user changes an interesting issue in one of the two windows, the other window still displays the information on the issue displayed as it is, and thus that causes a problem that a user undesirably sees information on different issues in two windows.

Further, in view of displaying information efficiently, since the properties of each sub-display section are still not diversified, standardized or subdivided, there is a problem that they cannot be diversified if standardized, and cannot be standardized if diversified.

### SUMMARY

One aspect of the invention provides an investment information providing system and a method thereof wherein a user can set sub-display sections of a main window.

Another aspect of the invention provides an investment information providing system and a method thereof wherein a user can set investment information categories displayed on sub-display sections of a main window according to his or her preference.

A further aspect of the invention provides an investment information providing system and a method thereof for providing pieces of information of investment information categories being displayed so that they can be organically related to each other.

According to a first aspect of the present invention, a system for providing a user with investment information needed by the user, the investment information being displayed in a window capable of being set by the user according to the user's intention, includes a window creating module for creating at least one sub-display section according to the user's setting in the window, the window created by the user or already having existed and assigned by the user, a window controlling module for controlling sub-elements related to each other in order to be synchronized with each other, the sub-elements assigned to be displayed in each the sub-display section according to the user's setting and a display module for displaying the sub-element in the sub-display section according to the user's setting.

According to a second aspect of the present invention, a method for providing a user with investment information needed by the user, the investment information being displayed in a window capable of being set by the user according to the user's intention, includes a first step of creating at least one sub-display section according to the user's setting in the window, the window created by the user or already having existed and assigned by the user, a second step of controlling sub-elements related to each other in order to be synchronized with each other, the sub-elements assigned to be displayed in each the sub-display section according to the user's setting and a third step of displaying the sub-element in the sub-display section according to the user's setting.

### BRIEF DESCRIPTION OF DRAWINGS

FIG. 1 is a block diagram schematically showing a usage example of an investment information providing system enabling a user to set a task screen.

FIG. 2 schematically shows an example of investment information categories in an embodiment.

FIG. 3 shows schematic block diagrams of an investment information providing system enabling a user to set a task screen according to an embodiment.

FIG. 4 schematically shows an example of the relation of sub-elements according to an embodiment.

FIG. 5a shows a window newly created by user's setting.

FIG. 5b shows an example of categories being selected by a user, one of which will be displayed in a main window.

FIG. 5c shows a first sub-display section created by user's setting.

FIG. 5d shows an example of categories being selected by a user to create a second sub-display section in a main window.

FIG. 5e shows two sub-display sections created by user's setting and arranged in the left and right halves of a main window.

FIG. 5e shows two sub-display sections created by user's setting and arranged in the upper and lower halves of a main window.

FIG. 6 shows an example of a window being displayed by an investment information providing system of an embodiment.

FIG. 7 is a flowchart showing a setting process for a task screen in an investment information providing method enabling a user to set a task screen according to a first embodiment.

FIG. 8 is a flowchart showing a process that sub-elements are displayed in a plurality of sub-display sections included in a window in an investment information providing method enabling a user to set a task screen according to an embodiment.

FIG. 9 is a schematic block diagram of an investment information providing system enabling a user to set a task screen according to a second embodiment.

### DETAILED DESCRIPTION OF CERTAIN EMBODIEMENTS

Hereinafter, exemplary embodiments of the present invention will now be described in detail with reference to attached drawings.

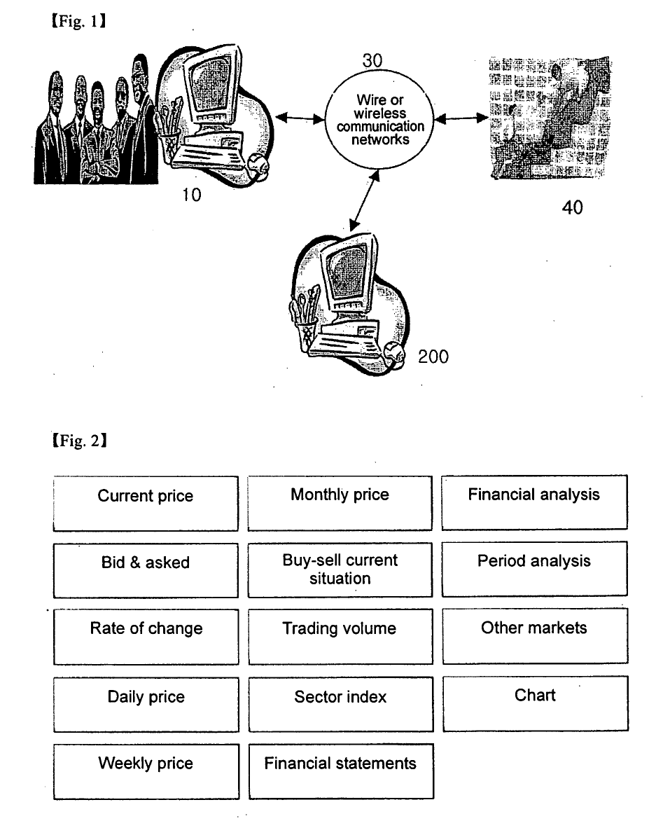

FIG. 1 is a block diagram schematically showing a process that an investment information providing system provides investment information to users according to an embodiment. In the investment information providing system enabling a user to set a task screen (hereinafter, referred to as an “investment information providing system” in short), a user can create or assign a window according to his or her preference or need using his or her computer system 10, and set a sub-display section in the window and categories about the investment information to be displayed in the sub-display section, etc. The investment information providing system 200, according to the user's setting, receives and displays the investment information from an investment information source 40 through wire or wireless communication networks 30 using Internet, a wireless terminal, etc. Alternatively, it hands over the investment information received to the user's computer system 10 so that the information can be displayed.

Particularly, if a sub-element being displayed by a sub-display section in a window is changed into a different sub-element or another sub-element is added to it, the investment information providing system 200 enables a sub-element related to the changed or added sub-element to be automatically displayed even in other sub-display sections in the window. Therefore, even if a user uniquely set a plurality of sub-display sections included in a window according to his or her preference or need, investment information organically related to each other can be provided in the plurality of sub-display sections.

Next, referring to FIG. 2, FIG. 2 schematically shows an example of investment information categories provided to a user according to an embodiement. As shown in the drawing, current price, bid and asked, price rate of change, period-based stock price, current situation on buying and selling, trading volume, financial statements, financial analysis, sector index, period analysis, various charts by category, etc. can be used as the investment information categories. In addition to stock information, categories about the information on futures, options, bonds, foreign exchange, foreign markets, etc. can be provided to a user. Moreover, categories on two or more markets may be displayed in each of sub-display sections included in a window or in two or more windows respectively by the system 200.

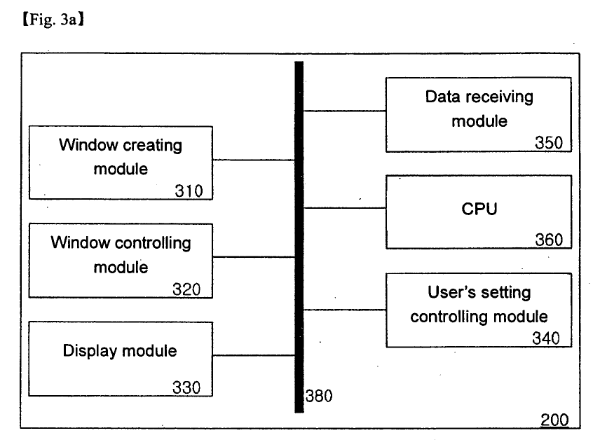

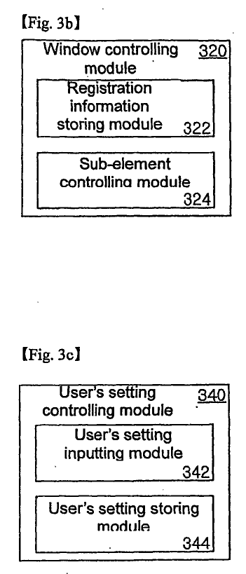

Next, referring to FIG. 3, FIG. 3 shows schematic block diagrams of an investment information providing system 200 according to an embodiment. As shown in the drawing, according to the embodiment, the investment information providing system 200 includes basic hardware such as a CPU 360 and software executed utilizing it, and further includes a window creating module 310, a window controlling module 320, a display module 330, a user's setting controlling module 340, and a data receiving module 350. The modules are coupled to each other through a bus 380.

The window creating module 310, according to user's setting, creates a window to be displayed by the investment information providing system 200 and a sub-display section within the window. There is no limit on the number of the windows and the sub-display sections included in the windows created by the window creating module 310. In other words, a user may set the system 200 to create two or more windows according to user's preference or set the number of sub-display sections included in each of the windows freely.

In addition, a user can set a plurality of windows to be displayed by the investment information providing system 200 without setting any sub-display section additionally. When a window is created, a user can freely set categories for each window and/or sub-display section. This will be described later.

Next, the window controlling module 320 stores registration information on all sub-elements of an investment information category set to be displayed in a window or a sub-display section included in the window created by the user's setting, and assigns the sub-elements to be displayed in the window and/or sub-display section based on this. The registration information on the sub-elements to be displayed in the window or the sub-display section included in the window means information on the properties of the sub-elements to be displayed such as a list, size, etc. other than investment information itself which is a sub-element.

Particularly, the window controlling module 320 checks whether two or more sub-elements to be displayed in each sub-display section are related to each other. Then, when a sub-element being displayed in a sub-display section of a window is changed or another sub-element is added to it, the window controlling module 320 displays one or more sub-elements that are related to the changed or added sub-element also in other sub-display sections of on the same window. In other words, sub-elements related to each other in a plurality of sub-display sections of in a window are synchronously displayed.

Here, with respect to a criterion whether sub-elements are related to each other, for example, sub-elements may be considered to be related to each other if their issue names or issue codes are the same. For example, if a sub-display section of a window is displaying the current price of a plurality of stock issues and other sub-display sections of the window are displaying the trading volume of a plurality of stock issues, one sub-element having the current price of a stock of a company as its value and another sub-element having the trading volume of the company as its value are considered to be related to (or have a relation with) each other. The criteria for such relation may be set by an administrator of the investment information providing system 200 in advance.

Further, the window controlling module 320 may include a registration information storing module 322 for storing the registration information on sub-elements displayed in a sub-display section included in a window, and a sub-element controlling module 324 for assigning sub-elements to be displayed in a sub-display section.

Next, the display module 330 displays sub-elements assigned by the window controlling module 320 in an assigned sub-display section, among investment information received from the investment information source 40.

Next, the user's setting controlling module 340 receives user's setting, and stores information on the window created based on the user's setting, sub-display section and/or category to be displayed therein. By the user's setting controlling module 340, the investment information providing system 200 can perform its display operation as it is by referring to the user's setting already stored, even if it recovers from power-off.

The user's setting can be inputted in the following manner. A user creates or activates a window, then creates sub-display sections by dividing the window into two or more horizontal and/or vertical sections, and then selects a category desired to be displayed in each of the sub-display sections. Alternatively, a user can activate an additional window which provides a menu and/or interface for user's setting, and then input his or her setting using the window. The manner of inputting user's setting, however, is merely an optional matter in designing, and it should be noted that the present invention is not limited to this embodiment.

According to an embodiment, the user setting controlling module 340 includes a user's setting inputting module 342 for receiving user's setting, and a user's setting storing module 344 for storing the inputted user's setting.

The data receiving module 350 performs data communications through general wire or wireless communication networks, and receives investment information provided by the investment information source 40.

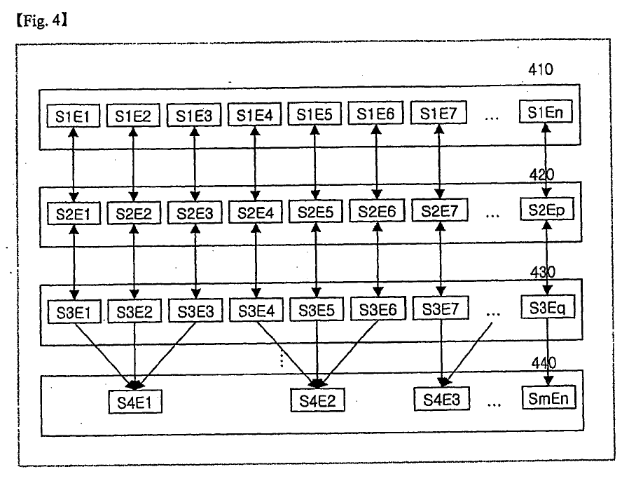

FIG. 4 schematically shows an example of the relation of sub-elements according to an embodiement. S1E1 to SmEn indicate the registration information of each sub-element. Here in SiEj, i indicates the i-th sub-display section included in a window, and j indicates the j-th sub-element to be displayed in the i-th sub-display section. In other words, SaEb represents that the b-th sub-element is displayed in the a-th sub-display section.

The sub-elements displayed in each sub-display section provide investment information for each issue of a category. For example, if the category of the sub-elements being displayed in the first sub-display section is the current price, S1E1 to S1En provide the information on the current price for each issue. In addition, if the category of the sub-elements being displayed in the second sub-display section 420 is the trading volume, the sub-elements S2E1 to S2Ep provide the information on the trading volume for each issue, and if the category of the sub-elements being displayed in the third sub-display section 430 is the financial statements, the sub-elements S3E1 to S3Eq provide the information on the financial statements for each issue.

In this case, among the sub-elements being displayed in other sub-display sections, the sub-elements having, e.g. the information on the same issue as their values are considered to be related to each other. If a sub-element in one of the sub-display sections is changed into another one or a new sub-element is added to be displayed, sub-elements related to the changed or added sub-element are charged or added in the other display sections as well.

In one embodiment, the sub-elements displayed in the first, second and third sub-display sections are related to the sub-element displayed in the fourth sub-display section. For example, if S1E1, S1E2 and S1E3 of the first sub-display section 410, S2E1, S2E2 and S2E3 of the second sub-display section 420, and S3E1, S3E2 and S3E3 of the third sub-display section 430 have investment information on semiconductor sector issues, and the sub-element S4E1 may have the semiconductor sector index as its data value. Then, all of the sub-elements S1E1, S1E2, S1E3, S2E1, S2E2, S2E3, S3E1, S3E2 and S3E3 in the first to third sub-display sections are related to the sub-element S4E1 in the fourth sub-display section.

In this case, due to the information properties, even if one of the sub-elements S1E1, S1E2, S1E3, S2E1, S2E2, S2E3, S3E1, S3E2 and S3E3 in the first to third sub-display sections is changed into a sub-element having the investment information on a different issue included in the same sector as its data value, the sub-element S4E1 in the fourth sub-display section is not changed. And that is also the same if a sub-element having the investment information on a different issue in the same sector is added to one of the first to third sub-display sections.

Meanwhile, each sub-display section may include two or more categories and sub-elements included in each of the categories. In addition, a sub-element in a sub-display section of a window may not be related to a sub-element of another sub-display section. In this case, even if there is a change of sub-element in a sub-display section, unrelated sub-elements are not charged.

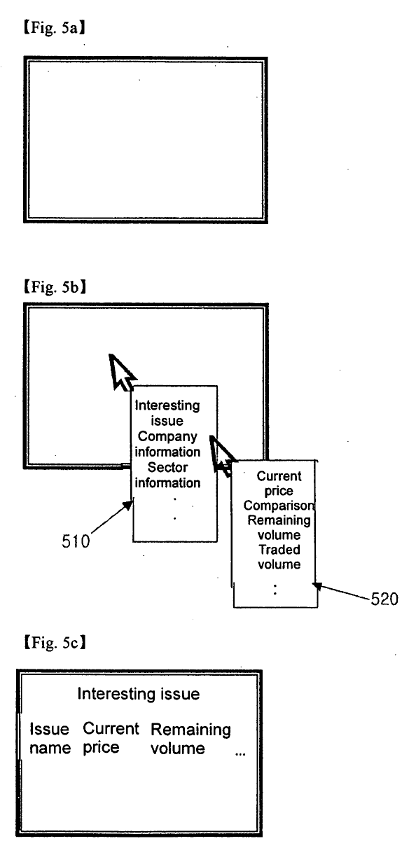

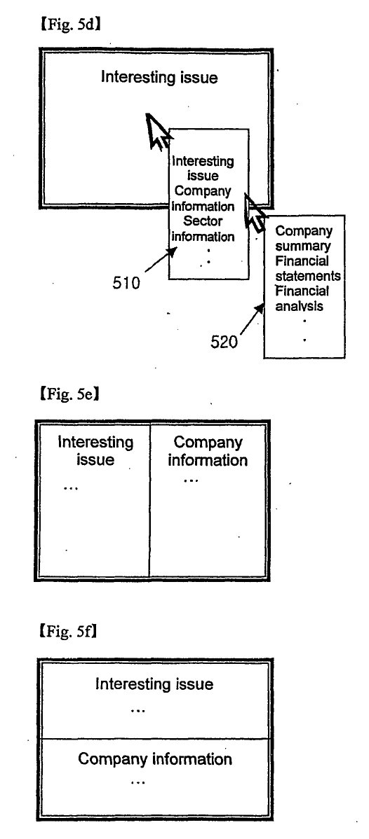

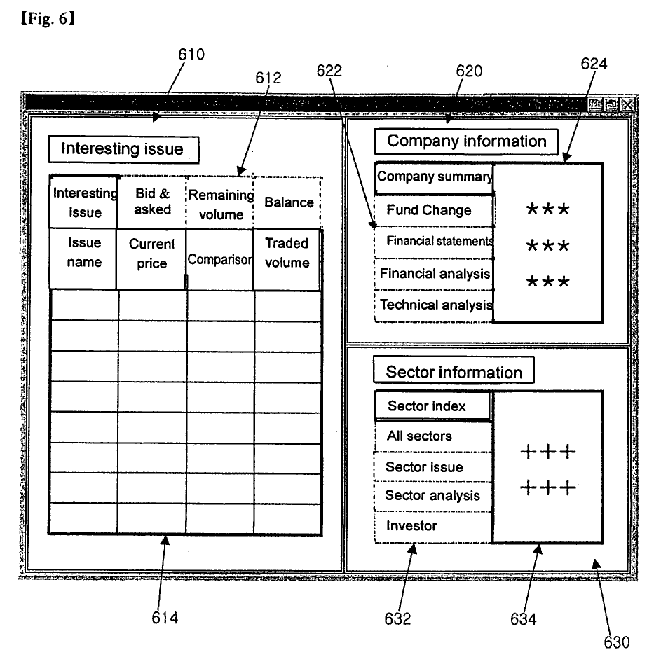

FIGS. 5a to 5f schematically show an example of the process of setting a window and sub-display sections by the investment information providing system 200. As shown in FIG. 5a, a new window can be created by an instruction of a user. Also, the window may be one already exiting. Since the widow is being activated by a user, it is referred to as a main window.

Next, as shown in FIG. 5b, when a user gives an instruction within a display section of the main window by, e.g. right-clicking his or her mouse, a selection listing 510 for selection from category groups of investment information is displayed over the main window. The user locates his or her mouse cursor over one of the category groups, and then a selection listing 520 for selection from categories included therein is displayed.

When the user selects each one of the category groups and categories, as shown in FIG. 5c, a first sub-display section is created. With such process repeated, as shown in FIGS. 5d and 5e, a new sub-display section is created.

As shown in FIGS. 5e and 5f, the arrangement of the created sub-display sections depends on user's preference. In addition, the size of the created window and sub-display section can also be adjusted according to user's selection, and it should be noted that a variable font whose size changes corresponding to the size of the window and sub-display section and a fixed font whose size is fixed regardless of the size may be used.

The selection listing 520 for selection may be independent of the seletion listing 510. The selection listings 510 and 520 for selection may be automatically provided when user's mouse cursor is placed at a certain position or a window is created. In addition to right-clicking, they can be displayed so that a user can select categories. And, it should be noted that before a sub-display section is created by user's selection, a function of a preview may be provided so as to check sub-display sections to be created, screen configuration of categories, and how sub-elements is displayed.

In another embodiment, a user may select a category to be displayed in each section after he or she divides a window into sub-display sections. Also in this case, how a window is divided, or how many sub-display sections are set is user's choice.

In addition, even though a sub-display section is already formed in an area of a window, a new sub-display section can be formed in the same area. In this case, one or more sub-display sections have been set on top of the other sub-display section(s) with a tag. Here, by selecting the tag, the underlying sub-display section can be activated and displayed while the previously displayed sub-display section is put under the activated sub-display section with a tag.

On a window being displayed in a format predetermined by the investment information providing system 200, a user can input or change his or her setting by drag-and-drop. The manner of inputting or changing user's setting is also not limited the above examples.

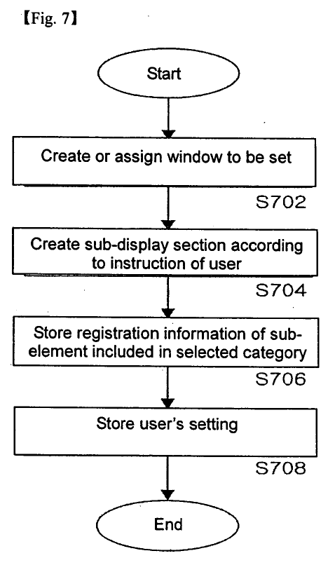

FIG. 6 shows an example of a window being displayed by the investment information providing system 200 of an embodiment. In FIG. 6, it appears that a user has devided the window into three sub-display sections, and sets them to display sub-elements included in the categories “interesting issue”, “company information” and “sector information”. As shown in the drawing, the user has set a sub-display section 610 displaying the sub-elements included in the category “interest issue” to occupy the left half of the window.

The sub-display section 610 of the interesting issue display “issue name”, “current price”, “comparison”, “volume”, etc. In the illustrated example, when a user clicks on one of the categories such as “bid and asked”, “remaining volume”, “balance”, etc., the sub-elements included in the category are set to be displayed in a tag 612 form.

In addition, the user arranges a sub-display section 620 for displaying the information on the category “company information” at the upper right of the window. The user selects “company summary”, “fund change”, “financial statements”, “financial analysis”, “technical analysis”, etc. as attached categories for the sub-elements to be displayed in the sub-display section 620, and sets each category in a tag 622 form so that the corresponding sub-elements can be displayed in an attached section 624 when it is selected.

Further, the user arranges a sub-display section 630 for displaying the information on the category “sector information” at the lower right of the window. The user selects “sector index”, “all sectors”, “sector issue”, “sector analysis”, “investor”, etc. as attached categories for the sub-elements to be displayed in the sub-display section 630, and sets each category in a tag 632 form so that the corresponding sub-elements can be displayed in an attached section 632 when it is selected.

In the window, if the user selects one of the sub-elements being displayed in the sub-display section 610 for “interesting issue”, the company information on the issue selected by the user is displayed in the sub-display section 620 for “company information”, and the sector information on the sector in which the selected issue is included is displayed in the sub-display section 630 for “sector information”.

Next, referring to FIG. 7, FIG. 7 is a flowchart showing a setting process for a task screen in an investment information providing method enabling a user to set a task screen according to an embodiment. First, a user gives an instruction to create a new window or selects one of already created windows so as to input his or her setting (step S702).

Then, the user divides the created or selected window into several ones according to his or her preference or need in order to create a plurality of sub-display sections, and assigns desired categories to the sub-display sections (step S704).

Then, the registration information on every sub-element to be displayed in each sub-display section included in the window is stored (step S706).

Then, the registration information on the window, sub-display sections and categories of each sub-display section set in the steps S702 to S706 is stored as user's setting (step S708).

The process through the steps cannot be performed only when a user inputs his or her setting for the first time, but when he or she changes his or her setting, or when he or she adds new setting.

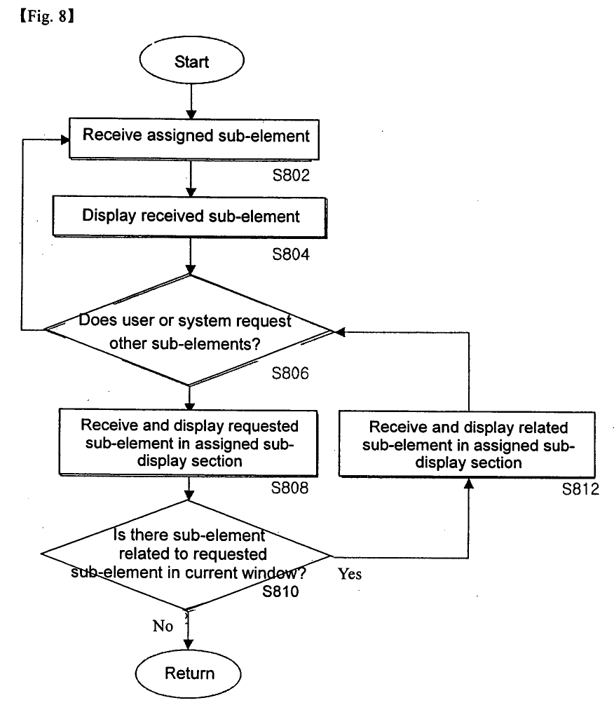

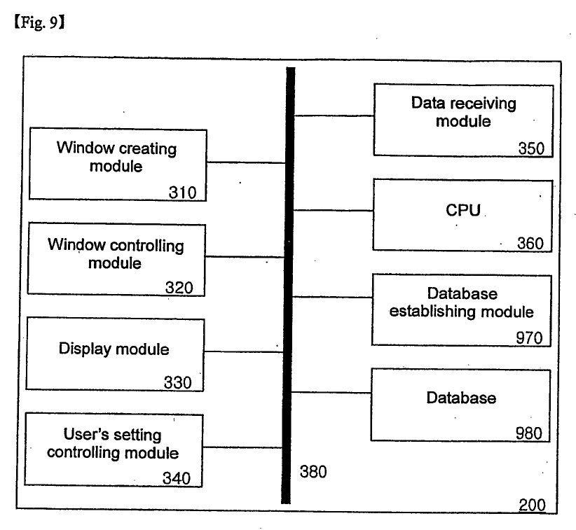

Referring to FIG. 8, FIG. 8 is a flowchart showing a process that sub-elements are displayed in a window including a plurality of sub-display sections according to an embodiment of the present invention.

First, the sub-elements selected to be displayed are received (step S802), and the received sub-elements are displayed in an assigned sub-displayed section (step S804).

Then, whether sub-elements other than ones being displayed are requested from a user or the investment information providing system 200 is judged (step S806). If there is no request as a result, the steps S802 and S804 are repeated.

On the other hand, there is a request for other sub-elements as a result of judgment in the step S806, the requested sub-elements are received and displayed in the assigned sub-display section (step S808).

Then, whether any of sub-elements to be displayed in other display sections in the window is related to the requested sub-elements is judged (step S810). As a result of judgment, if there is a sub-element having a relation, the investment information providing system 200 displays the sub-element having a relation an assigned sub-display section (step S812). Meanwhile, if any related sub-element is not received or retrieved, the existing sub-elements are preferably kept being displayed.

In the meantime, if there is no sub-element having a relation as a result of judgment in the step S810, the investment information providing system 200 returns to a predetermined step to perform the next operation or wait.

In the example shown in FIG. 8, the process is shown in the case that a user requests other sub-elements while the assigned sub-elements are being displayed in a plurality of sub-display section included in one window. In another embodiment, however, the already assigned sub-elements might not exist like when the system 200 starts to operate for the first time after user's setting. In this case, the system 200 may operate from the step S808 of requesting sub-elements by a user without the steps S802, S804 and S806,

FIG. 9 is a schematic block diagram of an investment information providing system 200 enabling a user to set a task screen according to another embodiment of the present invention. As shown in FIG. 9, investment information providing system 200 further includes a database establishing module 970 and a database 980.

The database establishing module 970 establishes the database 380 for sub-elements received from the investment information source 40. Unlike in other embodiments, where the sub-elements assigned to be displayed by a user are displayed by retrieving them from the investment information source 40, in this embodiment the sub-elements assigned to be displayed are displayed by retrieving them from the database 380.

In one embodiment, a user sets two or more windows and sub-display sections. Further, in another embodiment, each of a plurality of sub-display sections of a window created or assigned by a user may have properties as a window. In this case, the window controlling module controls a plurality of windows in the above manner. Although the present invention has been described by way of exemplary embodiments, it should be understood that those skilled in the art might make many changes and substitutions without departing from the spirit and the scope of the present invention which is defined only by the appended claims.

According to present invention, a user can be accommodated as he or she can freely set a window, sub-display sections and categories in sub-display sections when provided with investment information.

In addition, according to present invention, a user can be accommodated as he or she can be provided with pieces of information organically related to each other on issues set by him or her.

In addition, according to present invention, since a user can be provided with pieces of information organically related to each other on issues set by him or her, the number of windows can be reduced, thereby taking the burden of a system off.

What is claimed is:

1. A system for providing a user with investment information needed by said user, said investment information being displayed in a window capable of being set by said user according to said user's intention, comprising:
a window creating module for creating at least one sub-display section according to said user's setting in said window, said window created by said user or already having existed and assigned by said user;
a window controlling module for controlling sub-elements related to each other in order to be synchronized with each other, said sub-elements assigned to be displayed in each said sub-display section according to said user's setting; and
a display module for displaying said sub-element in said sub-display section according to said user's setting.

2. A system for providing a user with investment information as claimed in claim 1, wherein said window controlling module comprises:
a registration information storing module for storing registration information on said sub-element to be displayed in said sub-display section included in said window; and
a sub-element controlling module for assigning said sub-element to be displayed in said sub-display section by said display module.

3. A system for providing a user with investment information as claimed in claim 2, wherein said sub-element controlling module judges whether said sub-elements are related to each other based on said registration information stored by said registration information storing module, and thereby assigns said sub-elements related to each other to be displayed in said display sections by said display module.

4. A system for providing a user with investment information as claimed in claim 1 further comprising:
a database establishing module for establishing a database for said sub-elements to be displayed in each said sub-display section included in said window,
wherein said display module retrieves and displays said sub-element assigned by said window controlling module from said database.

5. A system for providing a user with investment information as claimed in claim 1 further comprising:
a user's setting inputting module for input of said user's setting; and
a user's setting storing module for storing said inputted user's setting.

6. A method for providing a user with investment information needed by said user, said investment information being displayed in a window capable of being set by said user according to said user's intention, comprising:
a first step of creating at least one sub-display section according to said user's setting in said window, said window created by said user or already having existed and assigned by said user;
a second step of controlling sub-elements related to each other in order to be synchronized with each other, said sub-elements assigned to be displayed in each said sub-display section according to said user's setting; and
a third step of displaying said sub-element in said sub-display section according to said user's setting.

7. A method for providing a user with investment information as claimed in claim 6, wherein said second step comprises:
a registration information storing step (2-1) of storing registration information on said sub-element to be displayed in said sub-display section included in said window; and
a sub-element controlling step (2-2) of assigning said sub-element to be displayed in said sub-display section.

8. A method for providing a user with investment information as claimed in claim 7, wherein said sub-element controlling step (2-2) further comprises a step of judging whether said sub-elements are related to each other based on said registration information stored in said registration information storing step (2-1), and thereby assigning said sub-elements related to each other to be displayed in said display sections.

9. A method for providing a user with investment information as claimed in claim 6 further comprising:
a database establishing step of establishing a database for said sub-elements to be displayed in each said sub-display section included in said window,
wherein said sub-element assigned in said third step is retrieved from said database and displayed during said third step.

10. A method for providing a user with investment information as claimed in claim 6 further comprising:
a user's setting inputting step of inputting said user's setting; and
a user's setting storing step of storing said user's setting inputted.
